(19) United States
(12) Patent Application Publication
(10) Pub. No.: US 2005/0144805 A1
(43) Pub. Date: Jul. 7, 2005

(54) Method and apparatus for removing moisture from a test sample

(76) Inventors: Sylvain Dominique Masset, Seigy (FR); Gary Warren McCurdy, Eldersburg, MD (US); Richard Alan Ruskey, Baltimore, MD (US)

Correspondence Address: MEREK, BLACKMON & VOORHEES, LLC, 673 South Washington Street, Alexandria, VA, 22314, US

(21) Appl. No.: 10/743,868

(22) Filed: Dec. 24, 2003

(51) Int. Cl. F26B 21/06; F26B 5/04

(52) U.S. Cl. 34/416; 34/80

(57) ABSTRACT

The present invention is direct to a method and apparatus for removing moisture from a test sample. A removable drying agent container having a plurality of drying agent particles is employed with a drying member so that the drying agent can be readily installed in and removed from the drying member.

### FIELD OF THE INVENTION

The present invention is directed to devices and processes used to remove moisture from a test sample. The test sample may be but is not limited to an aerosol.

### BACKGROUND OF THE INVENTION

Diffusion dryers have previously been used to remove moisture from a test sample such as an aerosol. TSI Incorporated of Shoreview, Minnesota sells a diffusion dryer under the Model No. 3062 that is used to remove moisture from an aerosol. The major components of this diffusion dryer include an inlet connector, a removable end cap, an outlet connector, a water trap, a drain valve and a desiccant dryer. The desiccant dryer includes two concentric cylinders. The inner cylinder is made of a wire screen and the outer cylinder is made of Plexiglas. The annular space between the cylinders is filled with a desiccant such as silica gel. It should be noted that other desiccants can be used. Aerosol enters the dryer at the end equipped with the water trap and exists at the opposite end. The desiccant is designed to absorb the moisture in the aerosol. The silica gel contains indicator crystals that are blue when dry and pink when wet. To dry the gel once it has changed colors so that it may be used again, it is necessary to disconnect the inlet and outlet connections and remove the dryer from its supports brackets when the dryer is mounted in a horizontal fashion. While the dryer is held in a vertical position, the end cap is removed and the dryer is turned upside down so that the silica gel crystals actually spill out of the dryer onto a tray or other container. The silica gel is then dried so that it may be reused. To reinstall the silica gel, it is necessary to again hold the dryer in a vertical position. A filling jig is installed on the inlet side of the dryer. The silica or other desiccant is then poured into the filling jig until the dryer body is almost full. The end cap is then secured to the dryer. The dryer is then placed in its holding cradles or supports and the fittings are reattached.

The model 3062 diffusion dryer has numerous disadvantages. Specifically, there are many shortcomings to the manner in which the desiccant is removed from and installed in the desiccant dryer. These shortcomings include but are not limited to: (1) the fact that the dryer must first be removed from its mounting brackets when mounted in a horizontal position in order to remove the silica gel; (2) the fact that the silica gel crystals are actually spilled out of the dryer; (3) the fact that a filling jig is used to reinstall the silica gel; and (4) the unnecessary time spent going through all the steps required to spill the silica gel out and reinstall the silica gel into the desiccant dryer using a filling jig.

### OBJECTS AND SUMMARY OF THE INVENTION

An object of a preferred embodiment of the present invention is to provide a novel and unobvious apparatus and/or process for removing moisture from a test sample.

Another object of a preferred embodiment of the present invention is to provide a method and/or apparatus that overcome the disadvantages associated with prior diffusion dryers.

A further object of a preferred embodiment of the present invention is provide a removable container for containing a plurality of drying particles that can be readily and easily removed from and installed in a dryer.

Yet another object of a preferred embodiment of the present invention is to provide a method and apparatus that eliminates the need for a filling jig when installing a drying agent into a dryer.

Still a further object of a preferred embodiment of the present invention is to provide a method and apparatus that eliminates the step of spilling out drying particles in the process of removing the drying agent from a dryer.

Yet still a further object of a preferred embodiment of the present invention is to provide a method and apparatus that eliminates the need for removing the dryer from a horizontal mounting in order to dispense or install a drying agent in the dryer

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, one embodiment of the present invention is directed to an apparatus for removing moisture from a test sample. The apparatus includes a drying member for drying a test sample passing through at least a portion of the drying member. The drying member includes a housing having at least first and second ends and a removable drying agent container disposed in at least a portion of the housing. A plurality of drying agent particles are stored and contained in the removable drying agent container for drying a test sample passing through at least a portion of the drying member. The housing has a movable portion that can be moved between a first position and a second position. When in the second position, the movable portion allows access to the removable drying agent container so that the removable drying agent container can be removed from the housing thereby removing all of the drying agent particles in the drying agent container together.

Another embodiment of the present invention is directed to a removable drying agent container for containing a plurality of drying agent particles for drying an aerosol. The removable drying agent container comprises a removable housing having a first end, a second end and a body portion. A plurality of drying agent particles are disposed in the removable housing for drying an aerosol. The removable housing permits the simultaneous removal of all of the drying agent particles in the removable housing from a drying member so that the drying agent particles can be rejuvenated or replaced.

A further embodiment of the present invention is directed to a method of drying a test sample. The method includes the steps of: (a) providing a drying member for drying a test sample passing through at least a portion of the drying member, the drying member including a housing having at least first and second ends and an inner cavity, the housing being sealed in a fluid tight manner; (b) providing a first removable drying agent container having a plurality of drying agent particles stored therein; (c) inserting the first removable drying agent container into the inner cavity of the housing; (d) passing a test sample through at least a portion of the drying member to dry the test sample; and, (e) after a predetermined time removing the first removable drying agent containing member from the drying member.

### BRIEF DESCRIPTION OF THE DRAWINGS

FIG. 1 is a perspective view of an apparatus formed in accordance with the most preferred embodiment of the present invention. A portion of the connecting tubing has been omitted at each end of the dryer assembly.

FIG. 2 is an end view of the apparatus depicted in FIG. 1.

FIG. 3 is a cross-sectional view of the apparatus depicted in FIG. 2 taken along lines A-A.

FIG. 4 is a perspective view of the removable drying agent container formed in accordance with the most preferred embodiment of the present invention.

FIG. 5 is an end view of the apparatus depicted in FIG. 4.

FIG. 6 is a cross-sectional view of the apparatus depicted in FIG. 5 taken along lines A-A.

FIG. 7 is a block diagram showing one of many possible uses of the present invention.

FIG. 8 is a block diagram showing another of many possible uses of the present invention.

### DETAILED DESCRIPTION OF THE PREFERRED EMBODIMENT OF THE INVENTION

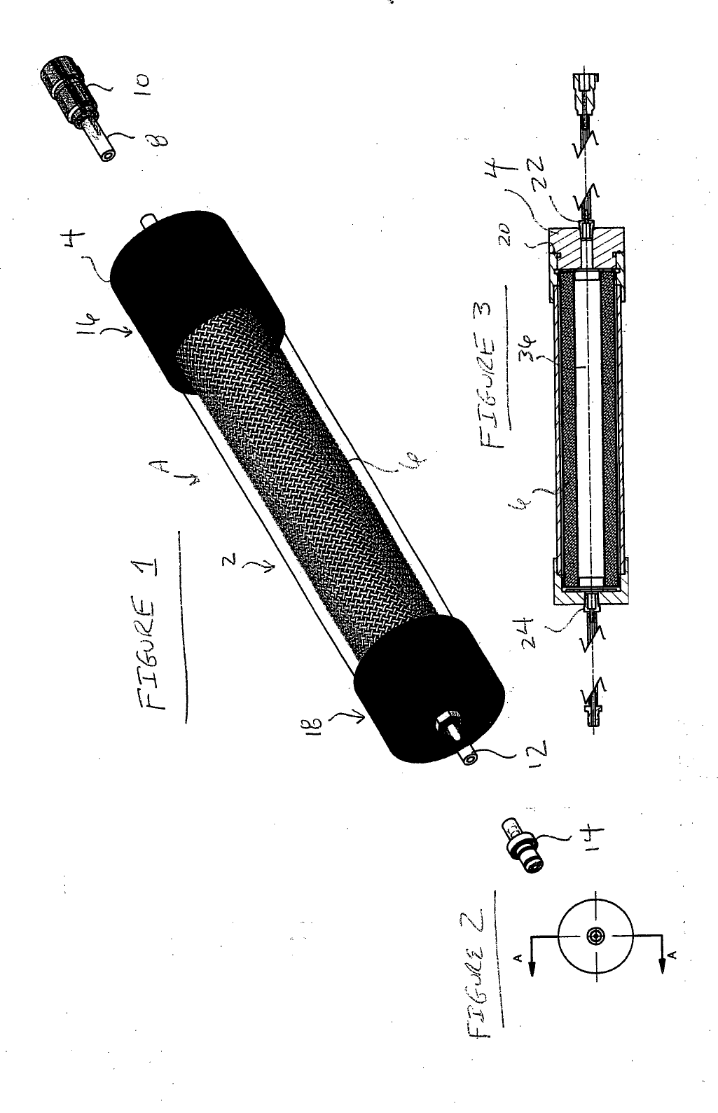

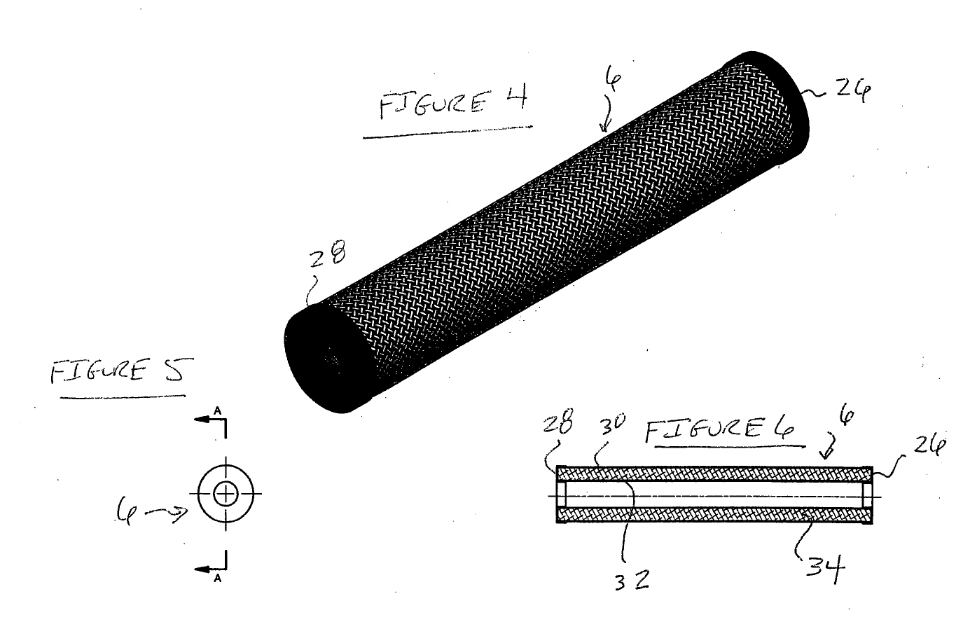

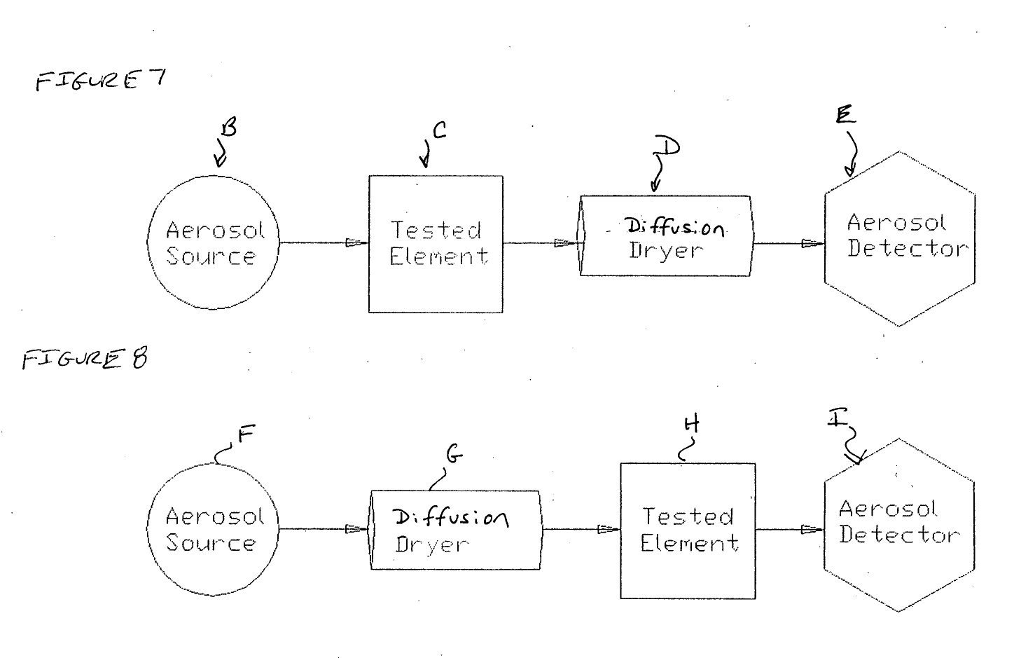

The most preferred form of the invention will now be described with reference to FIGS. 1-6. The appended claims are not limited to the most preferred embodiment and no term used herein is to be given a meaning other than its ordinary meaning unless accompanied by a statement that the term “as used herein is defined as follows”.

### FIGS. 1 THROUGH 6

Referring to FIGS. 1 to 6, a diffusion dryer assembly A is illustrated in one of many possible configurations. The diffusion dryer assembly A includes a housing 2, a removable end cap 4, a removable drying agent container 6, connecting tube 8, coupling 10, connecting tube 12 and coupling 14. Preferably, a portion of the housing 2 is formed from a transparent material so that the removable drying agent container 6 is visible through housing 2. The transparent material may be Plexiglas or any other suitable material.

The housing 2 includes first end 16 and second end 18. The first end 16 is internally threaded so that removable end cap 4 having corresponding threading can be threaded into the housing 2. An annular seal 20 ensures that a fluid tight chamber is formed once the removable end cap 6 is threaded into the housing 2. Serrated nipples 22 and 24 extend from removable end cap 4 and second end 18, respectively, so that connecting tubes 8 and 12 can be readily attached to housing 2. Preferably, one or both of couplings 10 and 14 are of the quick disconnect type. However, it will be readily appreciated that any suitable coupling member may be used.

Referring to FIGS. 4 to 6, the removable drying agent container 6 includes a first end cap 26, a second end cap 28, an outer porous surface 30, an inner porous surface 32 and a plurality of drying agent particles 34 disposed between outer porous surface 30 and inner porous surface 32. Preferably, end caps 26 and 28 are permanently fixed to surfaces 30 and 32. Preferably, the inner and outer porous surfaces 30 and 32 are formed from a wire mesh. Further, it is preferable that the wire mesh of inner surface 32 be finer than the wire mesh of outer surface 30. While a wire mesh is preferred, it will be readily appreciated that any suitable porous material may be used to form surfaces 30 and 32. The drying agent particles 34 may be a silica gel, activated charcoal, sodium aluminosilicte or any other suitable drying agent. It is preferable but not required that the drying agent change color when it is wet to indicate when the drying agent needs to be removed.

During operation, a test sample (e.g., an aerosol) is directed to the housing 2. The test sample travels from one end of the housing 2 to the other end through passageway 36. The drying agent 34 surrounding the passageway 36 removes moisture in the test sample. Once the drying agent 34 turns color it should be removed. This is accomplished by removing end cap 4 allowing access to the removable drying agent container 6. The container 6 may simply be removed from the housing 2. The housing 2 need not be oriented in a vertical manner to remove the container 6. Further, the housing 2 need not be removed from its mounting assembly to remove the container 6. Once removed, the container 6 may be replaced with a similar container. Alternatively, the container 6 may be put into an oven or suitable device to dry the particles of the drying agent 34 so that the particles may be reused. Once the particles are dried, the container 6 may be readily and easily re-installed into the housing 2.

Referring to FIGS. 7 and 8, two of many possible systems in which a diffusion dryer formed in accordance with the present invention may be utilized. In FIG. 7, the system includes an aerosol source B, a tested element C, a diffusion dryer D and an aerosol detector E. In this system, an aerosol is produced by the aerosol source B and is directed to the tested element C. The aerosol is then passed through the diffusion dryer D formed in accordance with the present invention. Moisture in the aerosol is removed by the diffusion dryer D. The aerosol is then directed to an aerosol detector E for processing. It should be noted that in this system, the aerosol is not conditioned by the diffusion dryer until after it has acted on the tested element.

Referring to FIG. 8, an aerosol is produced or generated by aerosol source F and transmitted to a diffusion dryer G formed in accordance with the present invention. The diffusion dryer G removes moisture from the aerosol. The conditioned aerosol is subsequently directed to the tested element H. The aerosol is then passed to the aerosol detector I for processing.

The aerosol source for either system could be a particle generator, an atomizer, a nebulizer, a condensation generator, an electrospray, a powder disperser, a vibrating orifice and/or a fluidized bed. It should be noted that the type of aerosol source is not in any way limited to the aforementioned examples but could include any suitable device. The tested element for either system can be a protective mask (e.g. a protective mask used by the military), respirators, filters and filter media of all types. Once again, the type of tested element is not to be limited to the aforementioned examples. The aerosol detector for either system can be a photometer, a laser particles counter, a condensation nuclei counter, a mobility sizer, an aerodynamic sizer/spectrometer, a nephelometer, a cascade impactor and/or an electrostatic precipitator. Like the aerosol source and the tested element, the aerosol detector is not limited to the examples mentioned above but rather can include any suitable device.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

1. An apparatus for removing moisture from a test sample, said apparatus comprising:
(a) a drying member for drying a test sample passing through at least a portion of said drying member, said drying member including a housing having at least first and second ends and a removable drying agent container disposed in at least a portion of said housing;
(b) a plurality of drying agent particles stored and contained in said removable drying agent container for drying a test sample passing through at least a portion of said drying member; and,
(c) said housing having a movable portion that can be moved between a first position and a second position, when in said second position said movable portion allows access to said removable drying agent container so that said removable drying agent container can be removed from said housing thereby removing all of said drying agent particles in said drying agent container together.

2. An apparatus as set forth in claim 1, wherein:
(a) said housing is sealed in a fluid tight manner.

3. An apparatus as set forth in claim 1, wherein:
(a) at least a portion of said housing is transparent.

4. An apparatus as set forth in claim 1, wherein:
(a) said drying agent particles are desiccant particles that change color when said desiccant particles are wet.

5. An apparatus as set forth in claim 1, wherein:
(a) said removable drying agent container has a first end, a second end and a body portion, said first end and said second end are fixed relative to said body portion such that said drying agent particles cannot be removed from said removable drying agent container.

6. An apparatus as set forth in claim 5, wherein:
(a) said removable drying agent container is substantially tubular in shape.

7. An apparatus as set forth in claim 1, wherein:
(a) said movable portion of said housing is a removable end cap.

8. An apparatus as set forth in claim 5, wherein:
(a) said body portion of said removable drying agent container has an outer porous surface permitting said drying agent particles to be viewed through said outer porous surface.

9. An apparatus as set forth in claim 5, wherein:
(a) said body portion of said removable drying agent container has a central passageway for permitting a test sample to pass there through.

10. An apparatus as set forth in claim 9, wherein:
(a) said drying agent particles surround said central passageway.

11. An apparatus as set forth in claim 10, wherein:
(a) said body portion of said removable drying agent container has an inner porous surface for permitting moisture in a test sample to be absorbed by said drying agent particles.

12. A removable drying agent container for containing a plurality of drying agent particles for drying an aerosol, said removable drying agent container comprising:
(a) a removable housing having a first end, a second end and a body portion;
(b) a plurality of drying agent particles disposed in said removable housing for drying an aerosol, said removable housing permitting the simultaneous removal of all of the drying agent particles in said removable housing from a drying member so that the drying agent particles can be rejuvenated or replaced.

13. An apparatus as set forth in claim 12, wherein:
(a) said first end and said second end are fixed relative to said body portion such that said drying agent particles cannot be removed from said removable housing.

14. An apparatus as set forth in claim 12, wherein:
(a) said body portion has an outer mesh surface permitting said drying agent particles to be viewed through said outer mesh surface.

15. An apparatus as set forth in claim 14, wherein:
(a) said body portion has a central passageway for permitting a test sample to pass there through.

16. An apparatus as set forth in claim 15, wherein:
(a) said drying agent particles surround said central passageway.

17. An apparatus as set forth in claim 16, wherein:
(a) said body portion has an inner mesh surface for permitting moisture in a test sample to be absorbed by said drying agent particles.

18. A method of drying a test sample, comprising the steps of:
(a) providing a drying member for drying a test sample passing through at least a portion of the drying member, the drying member including a housing having at least first and second ends and an inner cavity, the housing being sealed in a fluid tight manner;
(b) providing a first removable drying agent container having a plurality of drying agent particles stored therein;
(c) inserting the first removable drying agent container into the inner cavity of the housing;
(d) passing a test sample through at least a portion of the drying member to dry the test sample; and,
(e) after a predetermined time removing the first removable drying agent containing member from the drying member.

19. A method as recited in claim 18, including the further step of:
(a) inserting a second removable drying agent container into the inner cavity of the housing of the drying member after the first removable drying agent container has been removed from the drying member.

20. A method as recited in claim 18, wherein:
(a) the step of passing a test sample includes passing an aerosol through at least a portion of the drying member to dry the aerosol by removing unwanted moisture.
